(19) United States
(12) Patent Application Publication
(10) Pub. No.: US 2006/0193475 A1
(43) Pub. Date: Aug. 31, 2006

(54) Method for signing a dataset in a public key system and data processing system for carrying out said method

(75) Inventor: Danny Borke, Gammelsdorf (DE)

Correspondence Address: CROWELL & MORING LLP;INTELLECTUAL PROPERTY GROUP, P.O. BOX 14300, WASHINGTON, DC, 20044-4300, US

(73) Assignee: BAYERISCHE MOTOREN WERKE AKTIENGESELLSCHAFT, Muenchen (DE)

(21) Appl. No.: 11/347,210

(22) Filed: Feb. 6, 2006

Related U.S. Application Data
(63) Continuation of application No. PCT/EP04/06632, filed on Jun. 16, 2004.

(30) Foreign Application Priority Data
Aug. 6, 2003 (DE) 103 36 148.0

(51) Int. Cl. H04L 9/00

(52) U.S. Cl. 380/285

(57) ABSTRACT

A method for signing a dataset in a public key system is provided. An unsigned dataset is produced. The data set receives a first signature by producing a first signature using a first secret or private key from a pair of keys associated with an authorized person, the pair of keys comprising a public and secret key. The dataset is checked to see if the dataset is provided with the first signature or with other signatures of authorized persons. At least the dataset is provided with a second signature from a second authorized person by producing a third signature using the secret point if the dataset has already been signed by a predetermined number of authorized persons. A signed dataset is produced, the data set comprising at least the unsigned dataset and the third signature produced using the secret or private key of the signature point.

The present application is a continuation of International Application No. PCT/EP2004/006632, filed Jun. 16, 2004, and claims priority under 35 U.S.C. §119 to German Patent Application No. 103 36 148.0, filed Aug. 7, 2003. The entire contents of the aforementioned applications are herein expressly incorporated by reference.

### BACKGROUND AND SUMMARY OF THE INVENTION

The invention relates particularly to a method for signing a dataset in a public key system.

As used herein, the term “dataset” indicates a certificate in a public key system, software, software code, or computer program for controlling a sequence. The signing permits a checking as to whether the dataset has been changed after the signing.

A public key system is described in German Patent Document DE 101 40 721 A1. In the known public key method, asymmetrical keys are used; that is, in each case one complementary pair of keys consisting of a secret or private key and of a public key. A certificate in the sense of the known public key method, in particular, contains the relevant public key and, in particular, supplies information concerning the person or organization whose public key it is. In the case of the known public key method, the certificate is provided with a signature by a trust center or signature site, which signature indicates whether the certificate has been falsified or changed. For this purpose, normally a standard hash algorithm is applied to the certificate and the public key. The result is a hash value which unambiguously characterizes the certificate in addition to the public key. If the certificate is changed, this would result in a different hash value. The hash value is encoded by means of the secret key of the signature site. The result of this encoding is the so-called signature of the certificate. The signature, the certificate and the public key form the signed certificate. When checking whether the signed certificate or a portion thereof, for example, the public key, has been changed, the signature is decoded by means of the public key of the signature site. The result is a first hash value. Furthermore, the standard hash algorithm—as previously during the formation of the signature—is applied to the certificate in addition to the public key. The result is a second hash value. If the first has value and the second hash value correspond to one another, the signed certificate is considered to be unfalsified.

In particular, it is an object of the invention to indicate a method by means of which signed datasets can be produced in a controlled manner and which is nevertheless user-friendly.

In the case of the method according to the invention for producing a signed dataset, the not signed dataset, such as a certificate, is produced first.

The certificate may particularly have a limitation concerning the number of operating hours, a running or kilometer performance, a locally restricted validity (with respect to the location of the vehicle), a time indication or time duration, one or more vehicle types, one or more control devices or control device types, a chassis number or a control device number.

Furthermore, the certificate may have the public key of a trust center or of a (subordinate) signature site and/or of a clearing-code site and/or of a software signature site, particularly in accordance with German Patent Document DE 101 40 721 A1.

In the next step, the dataset is signed by generating a first signature while using a first secret or private key of a first authorized person.

In one aspect of the invention, the first secret key of the first person is provided by a first microprocessor chip card assigned to the first person. When using the chip card, the personal identification number—the so-called PIN—is preferably queried first. If the correct PIN is entered, according to an embodiment of the invention, the chip card can be used for signing while using the first secret or private key.

The unsigned dataset is preferably provided with the public key of the trust center or of the signature site and, while using the first secret or private key of a first authorized person is signed or provided with a first signature for the first time.

Optionally, for increasing the protection against misuse, the dataset provided with the first signature may be provided with one or more additional signatures of additional authorized persons.

In the next step, it is checked whether the dataset is provided with the first signature or if intended in an authorization concept for reasons of safety also with additional signatures of authorized persons.

If the data set is provided with the first signature or a predetermined number of signatures, at least the dataset is signed by a second or an additional authorized person while using the secret or private key of a pair of keys of a signature site.

In one aspect of the present invention, not only the dataset is signed while using the secret or private key of the pair of keys of the signature site. It is preferred to provide the unsigned dataset with the public key of the first signing person, and the unsigned dataset provided with the public key of the first person is signed by means of the private key of the first person.

If defined in the authorization aspect, the thus obtained dataset is provided by at least one other authorized person with the public key of that person, and the then obtained dataset is signed while using the public key by the additional person using the private key of that person.

In the event of the absence of only the signature of one single authorized person according to the fixed authorization aspect which defines, in particular, the number of persons whose signature is required, the then existing dataset is supplemented by the public key of this person, and the total dataset is signed using the private key of this person. The total dataset is then supplemented by the public key of the signature site, and everything is signed by using the private key of the signature site by this person. By means of the public key and the application of the hash algorithm, it can be unambiguously determined from the total dataset who signed the unsigned dataset at which signature site.

If only the maintaining of the authorization concept is important, without any proof of which concrete persons have signed, finally also only the unsigned dataset can be signed with the secret key of the signature site by the last person in the sequence. This keeps the total dataset small, which is advantageous, particularly for its data transmission.

Likewise, it is conceivable that the unsigned dataset is provided with a serial number or the like, and this total dataset is signed by means of the secret key of the signature site by the last person in the sequence. Under this serial number, particularly in other locations, the above-mentioned total dataset can then be stored for purposes of proof, which has all public keys and signatures of the participating persons as well as the public keys of the signature site and its signature caused by the last person.

In a preferred embodiment of the invention, the second secret key of the second person is provided by a microprocessor chip card assigned to the second person. When the chip card is used, preferably also the personal identification number (PIN) is queried first. If the correct PIN is entered, the chip card can be used for the signing while using the second secret or private key of the second person and when the first signature and, as required, the additional signatures are present, according to the authorization concept for the signing while using the secret or private key of the signature site.

Preferably, the secret keys are the secret keys of, in each case, another complementary pair of public keys.

A certificate signed according to the invention and negatively checked with respect to being unfalsified preferably permits the utilization or the release of the sequence of software or sequence control made available in a vehicle, such as a passenger car or motorcycle.

The method according to the invention has the particular advantage that a dataset, which can be checked with respect to its validity, particularly a certificate signed by using the secret key of the signature site or of the trust center, or signed software can only be produced if at least two authorized persons or sites have signed the unsigned dataset. If the dataset has already been provided with an authorized signature within the scope of the method of the invention, preferably the dataset, the public key of the trust center or the signature site and the first signature are checked as to whether they are unfalsified and are only then, if required, also provided with a signature by the next site or person. This checking with respect to being unfalsified by the next person or site takes place by using the public key of the first person or site.

In a preferred embodiment of the invention, the dataset produced according to the method of the invention is stored in the control device of a motor vehicle or motorcycle, preferably protected against a change or exchange, and a microprocessor provided in the control device checks the unfalsified condition of the dataset by means of the public key of the signature site or of the trust center.

In a preferred embodiment of the invention, the signed certificate produced according to the invention is stored in an area of the control device which is reliably protected against overwriting but is readable.

In a preferred embodiment of the invention, the control device is provided with a safety chip or a so-called crypto chip. The latter preferably has a sequentially controlled microprocessor and storage areas whose access is managed by the microprocessor and in which the public key of the signature site or of the trust center for checking the unfalsified condition of the dataset is stored while at least being protected against overwriting. The microprocessor preferably applies the hash algorithm to the dataset for determining the hash values in order to subsequently, while using the public key of the signature site or of the trust center and the signature of the signature site or of the trust center, check whether the dataset was changed after the signature of the signature site or of the trust center.

The safety chip preferably is a microprocessor circuit of the type known from Eurocheques or money cards or other bank cards. The circuit is characterized particularly in that the access to the security-critical data stored therein is controlled solely by the microprocessor of the chip, and its sequential control as well as the security-critical data and therefore the circuit are largely secure with respect to manipulation.

In a preferred embodiment of the invention, it is provided that such a safety chip or crypto chip is also used in the microprocessor cards of the signing persons or sites. The authorization concept or the sequential control of the authorization concept as well as the required public and secret keys can be stored and implemented in these microprocessor cards in a manner which is largely secure with respect to manipulation.

The invention will be described in detail in the following by means of an embodiment, that is, by means of a trust center signature certificate of German Patent Document DE 101 40 721 A1, which, during the production of a new vehicle, is stored in this vehicle in a manner which protects it against manipulation. However, this can also take place after the production and the sale of the vehicle, for example, upon the customer's request. It is understood that, in an analogous manner according to the invention, a clearing-code site signature certificate, a software signature certificate, the signature of clearing-code data or also the signature of software or software codes can be produced, i.e., a method in the case of which signatures are also implemented by at least two independent sites or persons.

### DETAILED DESCRIPTION OF THE PREFERRED EMBODIMENTS

The trust center signature certificate has at least the actual certificate and a signature by means of which the unfalsified condition of the trust center signature certificate can be checked. In this embodiment, the actual certificate has information concerning the respective trust center, a validity or usability limitation in the sense of German Patent Document DE 101 40 721 A1 and information concerning the first and concerning the second site or person which/who have “validated” or “have signed” the trust center signature certificate.

The trust center signature certificate is produced by the steps described in the following. The customer has ordered a new vehicle from the manufacturer. In the present embodiment, the order comprises a time-limited use of the software for operating a navigation system, a software-supported log book or other software or sequential control for the vehicle. The software is stored in the vehicle. However, it can only be used when a corresponding trust center signature certificate is present in the vehicle which, in addition, has a chassis number or the like which corresponds to the chassis number or the like of the vehicle. For this purpose, a trust center signature certificate is required in which it is indicated that the use of the above-mentioned software is released for the vehicle, for example, for one year.

When the vehicle is produced on the manufacturer's belt conveyor, a corresponding trust center signature certificate is requested from the trust center for implementing the customer's order. The trust center may be situated with the manufacturer of the vehicle or at an institution which is authorized by the manufacturer of the vehicle and can “clear” software (also) after the sale of the vehicle to the customer for the use by the customer, in that it transfers a corresponding trust center signature certificate into the vehicle, for example, by SMS or by way of another “path” of a mobile network. An authorized first site or first person checks whether the request is covered by the concrete order. If this is so and the request is to be implemented, a trust center signature certificate is generated which corresponds to the concrete request, and the public or not secret key of the first site or person, the public or not secret key of the trust center and the public key of a second site or person provided for the checking are attached to the trust center signature certificate.

A hash algorithm known in the case of public-key methods is applied to the concrete individualized trust center signature certificate and the attached public key of the first site or person, the public key of the second site or person and the public key of the trust center. The algorithm supplies a so-called hash value which is characteristic of the data of the concrete trust center signature certificate in combination with the concrete public key of the first site or person, the concrete public key of the second site or person and the concrete public key of the trust center. The hash value is encoded with the secret or private key of the first site or person. The hash value encoded by the first site or person is the (first) signature of the first site or person and identifies the concrete data combination.

According to the invention, at least one additional (i.e., the second) site or person checks whether the trust center signature certificate signed by the first site may be made available and whether the used public keys belong to the first site or person, to the second site or person and to the trust center.

If the second site or person has also determined that the request for the trust center signature certificate provided by the first site or person is justified, the second site or person checks whether the public key of the first site or person is authorized to sign; whether the public key of the second site or person is correct; whether the signature of the first site or person is present and, in fact, originates from the latter; and whether the public key of the trust center is actually that of the trust center. For this purpose, the public keys contained in the signed trust center signature certificate are compared with the public key of the first site or person known to be authorized, with the public key of the second site person known to be authorized, and with the public key of the trust center known to be authorized. If the comparison is positive in each case and therefore the one public key is considered to belong to the first site or person, the second public key is considered to belong to the second site or person, and finally the third public key is considered to belong to the trust center, the signature of the first site or person is checked with respect to its unfalsified condition in order to determine whether the first signature was in fact carried out by the first site or person.

This checking takes place in that the hash algorithm is applied by the second site or person to the trust center signature certificate and the public keys of the first site or person, of the second site or person and of the trust center added to the certificate. The result is a hash reference value. As mentioned above, the first signature of the first site or person represents the hash value encoded by means of the secret key by the first site or person. The first signature is decoded by the second site or person by means of the public key of the first site or person. The result is a hash value which is compared with the hash reference value determined by the second site or person.

If the two values correspond to one another, the trust center signature certificate is considered as approved by the first authorized site or person. If the second site or person also wants to approve the trust center signature certificate, the hash algorithm is applied to the trust center signature certificate, the public key of the first site or person, the public key of the trust center, the first signature and the public key of the second site or person. The result is another hash value. This hash value is encoded by the secret key of the second site or person and forms a second signature which is added to the trust center signature certificate.

The trust center signature certificate, the public keys of the first site or person, of the second site or person, of the trust center and the signatures of the first site or person and of the second site or person are transferred as a double-signed trust center signature certificate into the vehicle and are stored there, particularly in a control device.

A microprocessor provided in the control device, in a safety or crypto chip assigned to the control device, in a chip card or other locations in the vehicle checks whether the double-signed trust center signature certificate is unmanipulated by using the correct public keys and the hash algorithm. If required, the usability data or the usability limitations in the trust center signature certificate according to the invention determine the type and extent of the release of the software stored in the vehicle for the use by the driver of the corresponding vehicle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Method for signing a dataset in a public-key system, the method comprising the acts of:
generating an unsigned dataset;
a first signing of the dataset by the generating of a first signature while using a first secret or private key of a pair of keys of a first authorized person, the pair of keys consisting of a public and the secret key;
checking whether the dataset is provided with the first signature or also with additional signatures of authorized persons;
a second signing of at least the dataset by a second authorized person by generating a third signature while using the secret or private key of a pair of keys of a signature site, the pair of keys comprising a public and the secret key of the signature site if the dataset has as already been signed by a predetermined number of authorized persons; and
generating a signed dataset which has at least the not signed dataset and the third signature generated while using the secret or private key of the signature site.

2. The method according to claim 1, further comprising the act of:
a third signing of at least the dataset by the generating of a second signature while using a second secret or private key of a pair of keys, comprising of a public and the secret key of the second person.

3. The method according to claim 2, wherein information individualizing the dataset is added to the dataset before the first signing, the data set as well as the individualizing information is provided with the second signature, and at least the dataset provided with the second signature, the first signature and the third signature are unchangeably stored among the individualizing information at least at the signature site and a site authorizing the signature site in order to be able to unambiguously determine which persons or group of persons have signed the dataset.

4. The method according to claim 1, wherein the dataset is provided with the first signature, the second signature and the third signature.

5. The method according to claim 1, wherein the signed dataset is checked using the public key of the signature site with respect to its unfalsified condition and this public key is stored in a manner protected against any change at the location where the checking is taking place.

6. The method according to claim 1, wherein the dataset is a certificate which permits the usability or the sequence of operation of software made available in a vehicle, or the sequential control, or the dataset is the software or the sequential control.

7. The method according to claim 5, wherein the public key of the signature site is stored in the vehicle or in at least one control device of the vehicle in a manner protecting against change.

8. The method according to claim 6, wherein the certificate has a limitation of a number of operating hours, a running or kilometer performance, a locally limited validity with respect to the location of the vehicle, a time indication or time duration, one or more vehicle types, one or more control devices or control device types, a chassis number or a control device number.

9. The method according to claim 1, wherein the first secret key of the first person is stored by a first microprocessor chip card assigned to the first person, the second secret key of the second person is stored by a microprocessor chip card assigned to the second person, or the secret key of the signature site is stored in the first and in the second microprocessor chip card while being protected against change and read-out and is kept available for the signing of the dataset by the corresponding microprocessor chip card.

10. The method according to claim 9, wherein the sequential control of an authorization concept is stored in the first and the second microprocessor chip card, which authorization concept defines that the dataset has to be provided with at least the first signature before, using the secret or private key of the signature site, the dataset is signed or provided with the third signature.

11. The method according to claim 8, wherein the public key of each person of a plurality of persons who, within the scope of the authorization concept, are authorized to sign the dataset by means of a microprocessor chip card is stored in each of their microprocessor chip cards in a manner protecting against change in order to determine whether the first signature originates from an authorized person.

12. The method according to claim 11, wherein first microprocessor chip card is first released by the input of a personal identification number (PIN) for signing the certificate.

13. A control device comprising:
a dataset generated from an unsigned dataset by
a first signing of the dataset by the generating of a first signature while using a first secret or private key of a pair of keys of a first authorized person, the pair of keys consisting of a public and the secret key;
checking whether the dataset is provided with the first signature or also with additional signatures of authorized persons;
a second signing of at least the dataset by a second authorized person by generating a third signature while using the secret or private key of a pair of keys of a signature site, the pair of keys comprising a public and the secret key of the signature site if the dataset has as already been signed by a predetermined number of authorized persons; and
generating a signed dataset which has at least the not signed dataset and the third signature generated while using the secret or private key of the signature site;
a microprocessor that checks an unfalsified condition of the dataset at least by means of the public key of the signature site; and
a storage area, which is protected against change, and which stores the public key.

14. A data processing system, comprising a processor which executes processor readable code to perform the acts of:
generating an unsigned dataset;
a first signing of the dataset by the generating of a first signature while using a first secret or private key of a pair of keys of a first authorized person, the pair of keys consisting of a public and the secret key;
checking whether the dataset is provided with the first signature or also with additional signatures of authorized persons;
a second signing of at least the dataset by a second authorized person by generating a third signature while using the secret or private key of a pair of keys of a signature site, the pair of keys comprising a public and the secret key of the signature site if the dataset has as already been signed by a predetermined number of authorized persons; and
generating a signed dataset which has at least the not signed dataset and the third signature generated while using the secret or private key of the signature.

15. A computer program product stored in a storage medium, which causes a computer to perform the acts of:
generating an unsigned dataset;
a first signing of the dataset by the generating of a first signature while using a first secret or private key of a pair of keys of a first authorized person, the pair of keys consisting of a public and the secret key;
checking whether the dataset is provided with the first signature or also with additional signatures of authorized persons;
a second signing of at least the dataset by a second authorized person by generating a third signature while using the secret or private key of a pair of keys of a signature site, the pair of keys comprising a public and the secret key of the signature site if the dataset has as already been signed by a predetermined number of authorized persons; and
generating a signed dataset which has at least the not signed dataset and the third signature generated while using the secret or private key of the signature site.
